(19) United States
(12) Patent Application Publication
(10) Pub. No.: US 2026/0227488 A1
(43) Pub. Date: Aug. 6, 2026

(54) WIRELESS NETWORK DEVICE AND RADAR TRANSMISSION METHOD USING THE SAME

(71) Applicant: Realtek Semiconductor Corporation, Hsinchu (TW)

(72) Inventors: Cho-Han YU, Hsinchu (TW); Shau-Yu CHENG, Hsinchu (TW); Wen-Yung LEE, Hsinchu (TW); Min-Hsiang WANG, Hsinchu (TW); Mingzhi GUO, Jiangsu Province (CN); Chang-Ming LEE, Hsinchu (TW)

(21) Appl. No.: 19/344,562

(22) Filed: Sep. 30, 2025

(30) Foreign Application Priority Data
Feb. 5, 2025 (CN) 202510128741.6

(51) Int. Cl. G01S 7/40; H04B 1/18

(52) U.S. Cl. CPC G01S 7/4008; G01S 7/4021; G01S 7/4082; H04B 1/18

(57) ABSTRACT

A wireless network device includes a signal processing circuit, a transmitting circuit and a receiving circuit. The signal processing circuit generates an output signal including calibration chirps. The transmitting circuit transmits the output signal. The receiving circuit receives a signal corresponding to the output signal through a loop and to generate an input signal. The signal processing circuit compares the input signal with a reference frame signal and expected parameters to adjust a signal generator and a calibration circuit in the signal processing circuit. The signal generator generates measurement chirps in the radar frame. The transmitting circuit converts the output signal into a wireless emitting signal. The receiving circuit converts a wireless reflected signal corresponding to the wireless emitting signal into the input signal, so that the signal processing circuit generates multiple radar reflection information based on the input signal.

### CROSS-REFERENCE TO RELATED APPLICATION

This application claims priority to Chinese Application Serial Number 202510128741.6, filed Feb. 5, 2025, which is herein incorporated by reference in its entirety.

### BACKGROUND

### Field of Invention

The disclosure relates to wireless network device. More particularly, the disclosure relates to a wireless network device for radar detection.

### Description of Related Art

With the rapid development of technology, a target can be detected by radio waves (i.e. radar). Currently, most radar devices adopt the tradition way of analog demodulation to process the radar reflected signals, that is, extract information such as the distance, the orientation, or the rate of movement of the target from the radar reflected signals at the analog side before the Analog Digital Convertor (ADC). However, this method requires additional analog circuit configured at the analog side of the radar device to process the analog demodulation of the radar signals, which increases the hardware cost of the analog circuit.

In addition, the instability of circuit of the radar device may also affect the determination of the radar device in detecting the target. For example, the poor signal isolation between the transmitting end and the receiving end of the radar device may cause the signal energy emitted by the transmitting end to leak to the receiving end, and further affect the performance of the signal receiving function of the receiving end; or, the temperature change of the radar device caused by the signal transmission for a long time, and the switching of multiple operation modes such as transmission, reception, and standby, etc., may cause unstable changes of the signal energy at the transmitting end and the signal latency, phase and amplitude at the receiving end, thereby affecting the detection of the target by the radar device, and further affecting the overall performance of the radar device.

In addition, there is a trend for many WiFi devices to be connected with APs. Therefore, it is needed to combine the radar function with WiFi devices to demodulate radar reflected signals without increasing the hardware cost of analog circuit to solve the above technical problems.

### SUMMARY

A purpose of the present disclosure is to provide a wireless network device comprising a signal processing circuit, a transmitting circuit, and a receiving circuit. The signal processing circuit comprises a signal generator for generating an output signal, wherein during radar transmission operation, the output signal comprises a plurality of calibration chirps in a radar frame. The transmitting circuit is configured to convert the output signal to a wireless emitting signal. The receiving circuit is configured to receive and convert a wireless reflected signal corresponding to the wireless emitting signal to an input signal. The signal processing circuit includes a calibration circuit configured to set the input signal corresponding to the reference frame as a reference frame signal, and to compare the input signal with the reference frame signal to adjust the signal generator and the calibration circuit. The signal generator is further configured to generate a plurality of measurement chirps in the radar frame, so that the signal processing circuit generates a plurality of radar reflection information according to the input signals corresponding to the measurement chirps.

In one embodiment, the calibration circuit comprises an energy calibration unit configured to calculate an energy deviation based on an energy difference and an expected energy difference between the input signal and the reference frame signal, and the energy calibration unit generates and transmits a control signal to the signal generator according to the energy deviation; wherein, the signal generator adjusts the output signal to a compensated output signal according to the control signal, and the energy calibration unit outputs an energy calibration signal according to the input signal corresponding to the compensated output signal.

In one embodiment, the calibration circuit further comprises a latency calibration unit coupled to the energy calibration unit and configured to calculate a latency deviation based on a receiving time of the energy calibration signal and an expected receiving time of the reference frame signal, and the latency calibration unit adjusts the energy calibration signal to a latency calibration signal according to the latency deviation.

In one embodiment, the calibration circuit further comprises a phase and amplitude calibration unit coupled to the latency calibration unit and configured to calculate a phase deviation based on a phase value of the latency calibration signal and a reference phase value of the reference frame signal, calculate an amplitude deviation based on an amplitude value of the latency calibration signal and a reference amplitude value of the reference frame signal, and adjust the latency calibration signal to a calibration signal according to the phase deviation and the amplitude deviation.

In one embodiment, the signal processing circuit further comprises a measurement circuit coupled to the phase and amplitude calibration unit and configured to analyze the calibration signal to obtain the radar reflection information.

In one embodiment, the calibration signal contains the measurement chirps of the radar frame.

In one embodiment, the signal processing circuit sets an initial radar frame in a time slot as the reference frame.

In one embodiment, the signal processing circuit further comprises a storage circuit coupled to the calibration circuit and configured to record a plurality of parameters of the reference frame. The parameters comprise a reference energy value, an expected receiving time, a reference phase value, and a reference amplitude value.

In one embodiment, the signal processing circuit performs the radar transmission operation and the wireless network transmission operation in a plurality of time slots different from each other; during the radar transmission operation, the output signal is in a first frequency band; during the wireless network transmission operation, the output signal is in a second frequency band. The first frequency band is different from the second frequency band.

Another purpose of the present disclosure is to provide a radar transmission method for a wireless network device, and the radar transmission method comprises: generating an output signal, wherein the output signal includes a plurality of calibration chirps of a radar frame in a radar transmission operation; converting the output signal to a wireless emitting signal; converting a wireless reflected signal corresponding to the wireless emitting signal to an input signal; setting the input signal corresponding to a reference frame as a reference frame signal; comparing the input signal and the reference frame signal to generate a plurality of measurement chirps in the radar frame; generating a plurality of radar reflection information according to the input signal corresponding to the plurality of measurement chirps.

Therefore, the wireless network device of the present disclosure combines the radar function to perform the radar transmission operation and the WiFi transmission operation, and performs digital demodulation of the input signal at the digital side of the wireless network device (i.e., the signal processing circuit communicatively connected after the receiving circuit) to reduce the hardware cost of the analog circuit, and to reduce the signal energy at the transmitting end, the signal latency and the phase and amplitude deviations at the receiving end, thereby enhancing the overall performance of the wireless network device.

It is to be understood that both the foregoing general description and the following detailed description are demonstrated by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a function block diagram of a wireless network device according to an embodiment of the present disclosure;

FIG. 2 is a schematic diagram illustrating the transmission of the output signal of the wireless network device in FIG. 1 during the radar transmission operation and the wireless network transmission operation;

FIG. 3A is a functional block diagram of the signal processing circuit in FIG. 1;

FIG. 3B is a flow chart of a radar transmission method for the wireless network device in FIG. 1; and

FIG. 4 is a schematic diagram of the radar frame structure of the output signal.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Because most radar devices nowadays perform analog demodulation for the radar reflected signals at the analog side before the Analog Digital Converter (ADC), the hardware cost of the analog circuit is relatively high. In addition, the instability of the radar device's own circuits causes the signal energy at the transmitting end and the signal latency, phase and amplitude deviations at the receiving end, which affects the detection of the target by the radar device. In addition, there has been a trend of connecting many wireless networking (WiFi) devices to access points (APs). Therefore, the present disclosure provides a WiFi device combining the radar function to perform radar transmission operations and WiFi transmission operations, and perform digital demodulation of radar reflected signals at the digital side of the WiFi device to reduce the hardware cost of the analog circuits, to reduce the signal energy at the transmitting end, the signal latency, the phase and the amplitude the deviations at the receiving end, and thus to improve the overall performance of the WiFi device.

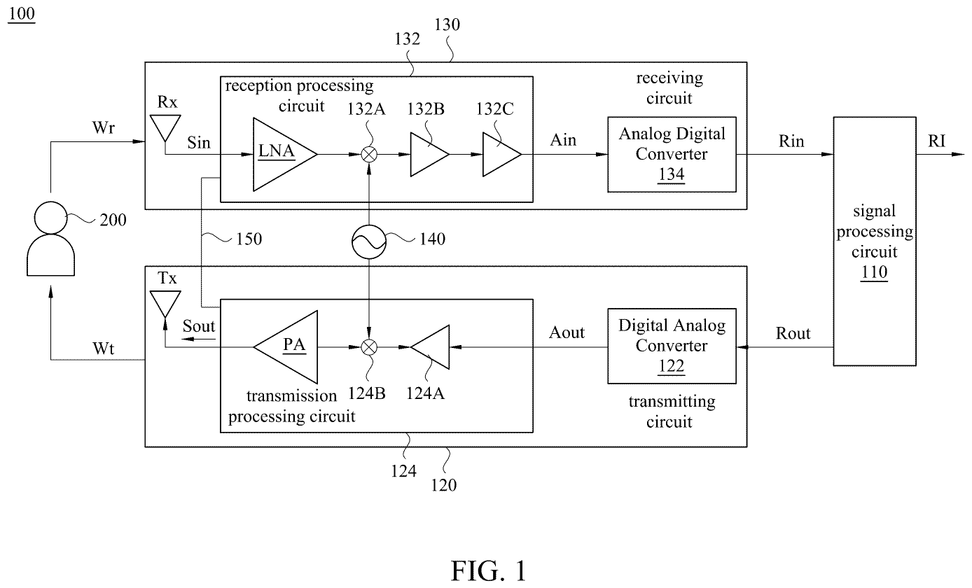

Please refer to FIG. 1, which is a function block diagram of a wireless network (WiFi) device 100 according to an embodiment of the present disclosure. As shown in FIG. 1, the WiFi device 100 comprises a signal processing circuit 110, a transmitting circuit 120, a receiving circuit 130, and an oscillation circuit 140. In one embodiment, the WiFi device 100 can be a Radio Frequency (RF) front-end module for a wireless communication device such as a smart phone, a base station, a satellite, etc., and can be configured for performing radar transmission operations and wireless network (WiFi) operations, but it is not limited thereto in the preset disclosure. In some embodiments, the WiFi device 100 is configured to convert data signal into a wireless emitting signal (for example, Wt) for emission, and also to convert the received wireless signal (for example, Wr) into data signal for further processes.

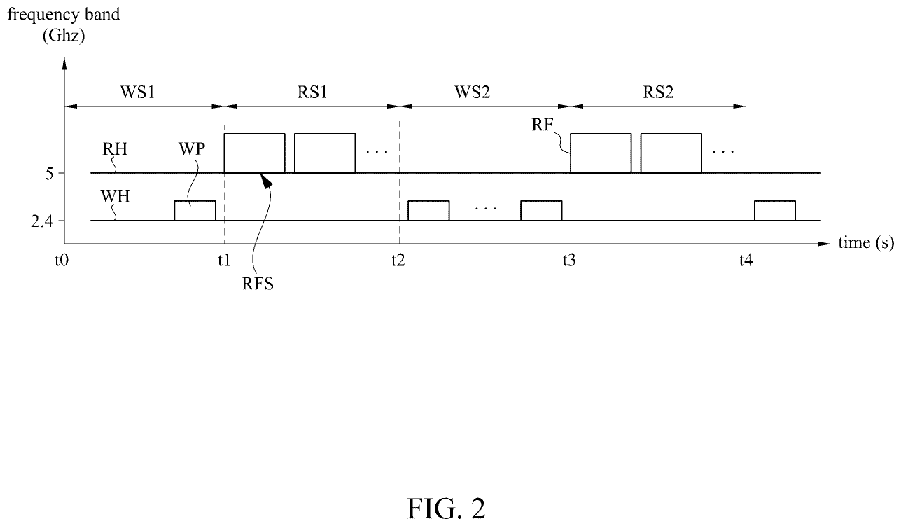

Please refer to FIG. 1 and FIG. 2 together, in which FIG. 2 is a schematic diagram illustrating the transmission of the output signal Rout of the WiFi device 100 in FIG. 1 during the radar transmission operation and the wireless network transmission operation. As shown in FIG. 1 and FIG. 2, the WiFi device 100 respectively performs the radar transmissions operation and the WiFi transmission operations in a plurality of time slots RS1-RS2, WS1-WS2. During the radar transmission operation, the wireless emitting/receiving signal is in a first frequency band RH, as shown in FIG. 2. During the WiFi transmission operation, the wireless emitting/receiving signal is in a second frequency band WH, as shown in FIG. 2. In one embodiment, the first frequency band RH is different from the second frequency band WH, e.g., the first frequency band RH can be 5 GHz, and the second frequency band WH can be 2.4 GHz, but it is not limited thereto in the present disclosure. It should be noted that the number of time slots for performing the radar transmission operations and the WiFi transmission operations is not limited to two.

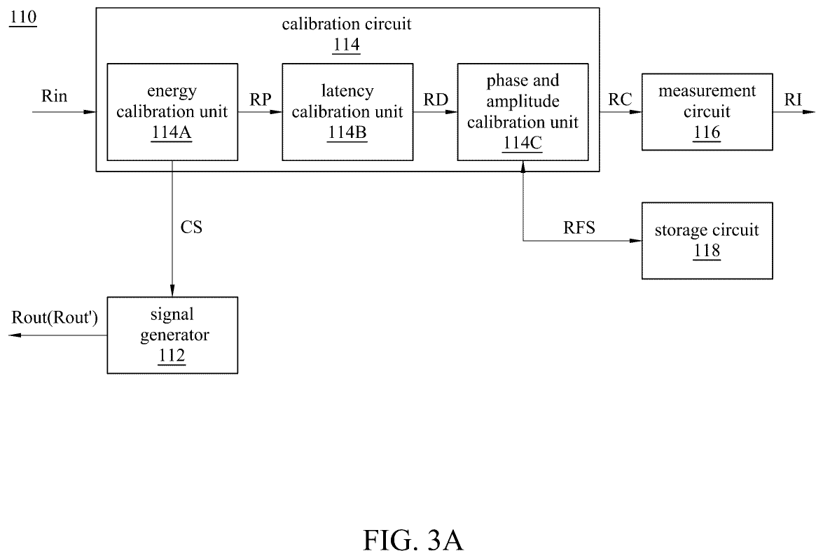

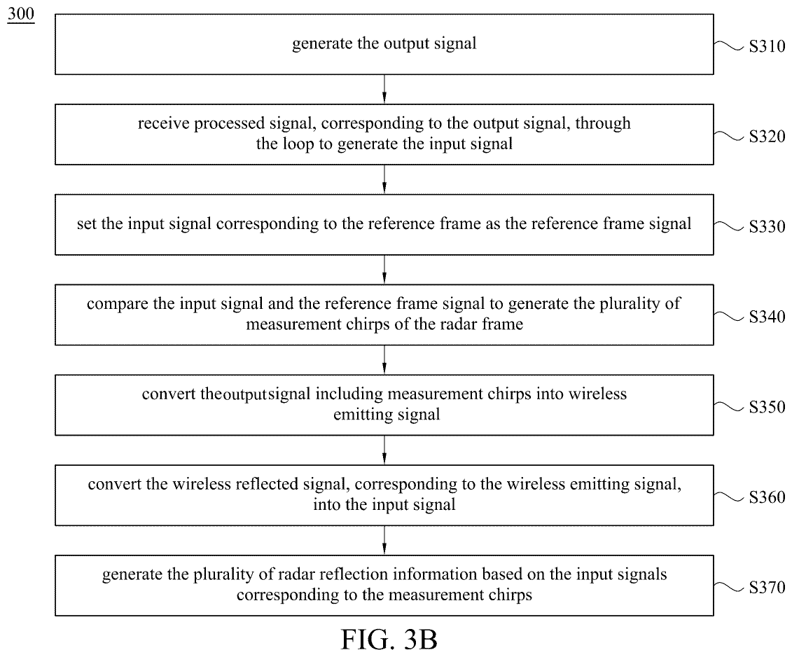

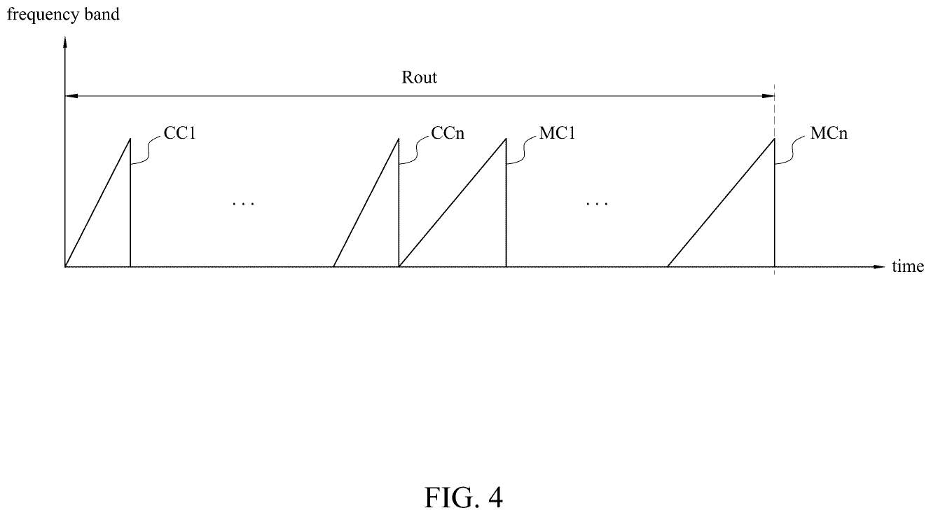

In one embodiment, as shown in FIG. 2, the WiFi device 100 in radar transmission operations sets the initial radar frame among a plurality of radar frames RF in each time slot (e.g., RS1) as the reference frame RFS, and the initial radar frame is the radar frame RF generated by the signal processing circuit 110 for the first time. Regarding the specific functional operation of the radar frames RF and the reference frames RFS, please refer to the below discussions in FIG. 3A, FIG. 3B, and FIG. 4.

Therefore, the WiFi device 100 performs the radar transmission operation and the WiFi transmission operation through different frequency bands and different time slots, which reduces the signal interference between the radar transmission and WiFi transmission, and can enhance the overall performance of the WiFi device 100 when performing radar ranging.

Returning to FIG. 1, in one embodiment, the signal processing circuit 110 can be a Baseband Processor (BP) and can be configured to generate digital signals (e.g., the output signal Rout in FIG. 1), but it is not limited thereto in the present disclosure. The transmitting circuit 120 is coupled to the signal processing circuit 110 and includes a Digital Analog Converter (DAC) 122, a transmission processing circuit 124, and a transmitting end Tx. In one embodiment, as shown in FIG. 1, the DAC 122 is coupled to the signal processing circuit 110 and performs the digital-to-analog conversion of the output signal Rout received from the signal processing circuit 110. The transmission processing circuit 124 is coupled to the DAC 122 and performs the signal processing to generate wireless signal-like signal (e.g., Sout) transmitted to the transmitting end Tx. The transmitting end Tx correspondingly emits a wireless emitting signal Wt.

Specifically, in one embodiment, as shown in FIG. 1, the transmission processing circuit 124 can consist of a filter 124A, a mixer 124B and a power amplifier PA connected in series. The filter 124A is coupled to the DAC 122 and is configured to filter the noise of the transmission signal Aout. The mixer 124B is coupled to the filter 124A and the oscillation circuit 140, and is configured to add the frequency of the output signal from the oscillation circuit 140 and the frequency of the transmission signal Aout to generate a reasonable frequency range, so as to adjust the frequency of the transmission signal Aout in the reasonable frequency range. The power amplifier PA is configured to amplify the transmission signal Aout to generate the output signal Sout. In one embodiment, the oscillation circuit 140 can be a voltage-controlled oscillatior (VCO). The transmitting end Tx can be an antenna and converts the output signal Sout to the wireless emitting signal Wt, but it is not limited thereto in the present disclosure. In one embodiment, the transmission signal Aout can be an analog signal and the wireless emitting signal Wt can be a radio frequency signal, but it is not limited thereto in the present disclosure.

As shown in FIG. 1, the receiving circuit 130 is coupled to the signal processing circuit 110 and including a reception processing circuit 132, an Analog Digital Converter (ADC) 134, and a receiving end Rx. In one embodiment, as shown in FIG. 1, the receiving end Rx receives a wireless reflected signal Wr generated by an object to be tested 200 reflecting the wireless emitting signal Wt, and converts it into an input signal Sin. The reception processing circuit 132 is coupled to the receiving end Rx and performes signal processing to the input signal Sin. The ADC 134 is coupled to the reception processing circuit 132 and performs the analog-to-digital conversion of the received signal Ain into an output signal Rin. In one embodiment, as shown in FIG. 1, the reception processing circuit 132 can consist of a low noise amplifier LNA, a mixer 132A, an amplifier 132B, and a filter 132C connected in series. The low noise amplifier LNA is coupled to the receiving end Rx and is configured for the amplification and noise reduction of the input signal Sin. The mixer 132A is coupled to the low noise amplifier LNA and the oscillation circuit 140, and is configured to add the frequency of the output signal from the oscillation circuit 140 and the frequency of the input signal Rin to generate a reasonable frequency range, so as to adjust the frequency of the input signal Sin in the reasonable frequency range. The amplifier 132B is coupled to the mixer 132A and is configured to amplify the input signal Sin. The filter 132C is coupled to the amplifier 132B and is configured to filter the noise of the input signal Sin. In one embodiment, the receiving end Rx can be an antenna, but it is not limited thereto in the present disclosure. In one embodiment, as shown in FIG. 1, the object to be tested 200 can be a dynamic object or a static object (e.g., a person, a cat, a dog, a tree, or a rock), but it is not limited thereto in the present disclosure. In one embodiment, the wireless reflected signal Wr can be a radio frequency signal, the received signal Ain can be an analog signal, and the input signal Rin can be a digital signal, but it is not limited thereto in the present disclosure.

Therefore, the signal processing circuit 110 receives and generates a plurality of radar reflection information RI according to the input signal Rin. In one embodiment, the radar reflection information RI can be a relative position, a relative distance, a relative orientation, or a relative rate of movement of the object to be tested 200 relative to the WiFi device 100, but it is not limited thereto in the present disclosure. Regarding the specific functional operation of the signal processing circuit 110 generating the radar reflection information RI according to the input signal Rin, please refer to the below discussions in FIG. 3A and FIG. 3B.

Please refer to FIG. 3A, which is a functional block diagram of the signal processing circuit 110 in FIG. 1. As shown in FIG. 3A, the signal processing circuit 110 includes a signal generator 112, a calibration circuit 114, a measurement circuit 116, and a storage circuit 118. In one embodiment, the signal generator 112, the calibration circuit 114, the measurement circuit 116, and the storage circuit 118 can be partially or independently configured out of the signal processing circuit 110, but it is not limited thereto in the present disclosure.

It should be noted that the signal generator 112 can be an Arbitrary Waveform Generators (AWG), a function signal generator or a radio frequency microwave signal generator, the calibration circuit 114 can be a Power Factor Calibration (PFC) circuit, the measurement circuit 116 can be an oscilloscope, and the storage circuit 118 can be a memory, a Universal Serial Bus (USB) disk, a hard disk, a CD-ROM, a USB flash drive, or any other storage medium or circuit having the same function and known by those of ordinary skill in the art of the present disclosure, but it is not limited thereto in the present disclosure.

As shown in FIG. 3A, the signal generator 112 is configured to generate the output signal Rout. Please refer to FIG. 4, which is a schematic diagram of the structure of the radar frames RF of the output signal Rout in FIG. 2 and FIG. 3A. As shown in FIG. 4, during the radar transmission operation, the output signal Rout in FIG. 2 and FIG. 3A includes a plurality of calibration chirps CC (e.g., CC1 to CCn) and a plurality of measurement chirps MC (MC1 to MCn) in the radar frame RF. In one embodiment, the signal generator 112 is configured to sequentially generate the plurality of calibration chirps CC and the plurality of measurement chirps MC in the radar frame RF.

Continuously, reference is made to FIG. 1 together. The transmitting circuit 120 processes the output signal Rout for transmitting it as the output signal Sout to the reception processing circuit 132 through a loop 150 in the WiFi device 100. The receiving circuit 130 further generates the input signal Rin based on the received signal. It should be noted that, in some embodiments, the aforementioned operations merely correspond to time sequence of the calibration chirps in the radar frame RF. In the time sequence of the measurement chirps in the radar frame RF, the receiving circuit 130 generates the input signal Rin based on the wireless signal received at the receiving end.

Reference is then made to FIG. 3A. The calibration circuit 114 sequentially receives corresponding calibration chirps in the input signal Rin to adjust the signal generator 112 based on the calibration chirps and further obtains calibration parameters associated with latency, phase, and amplitude, in order to calibrate the measurement chirps in subsequent received input signal Rin for obtaining accurate radar reflection information RI.

As shown in FIG. 3A, the calibration circuit 114 is coupled to the signal generator 112 and includes an energy calibration unit 114A, a latency calibration unit 114B, and a phase and amplitude calibration unit 114C. In one embodiment, the energy calibration unit 114A, the latency calibration unit 114B, and the phase and amplitude calibration unit 114C can be partially or independently configured outside of the calibration circuit 114 and within the signal processing circuit 110, or can be partially or independently configured outside of the signal processing circuit 110, but it is not limited thereto in the present disclosure.

Specifically, as shown in FIG. 3A, the energy calibration unit 114A is configured to calculate an energy deviation based on energy of the calibration chirp CC1 of the first timing in the input signal Rin and an expected energy, and to generate a control signal CS corresponding to the energy deviation. Therefore, the signal generator 112 is configured to compensate for the energy deviation to the output signal Rout according to the control signal CS from the energy calibration unit 114A to change the output signal Rout as the compensated output signal Rout′. Alternatively stated, the signal generator 112 adjusts energy of subsequent calibration chirps and measurement chirps in the compensated output signal Rout′. The energy calibration unit 114A then is configured to receive the input signal Rin, corresponding to the compensated output signal Rout′, as the energy calibrated signal RP.

As shown in FIG. 3A, the latency calibration unit 114B is coupled to the energy calibration unit 114A and is configured to calculate a latency deviation based on the energy calibrated signal RP and an expected receiving time. For example, in some embodiments, the energy calibrated signal RP includes a calibration chirp CC2 corresponding to the second timing in the input signal Rin. The latency calibration unit 114B calculate latency deviation between the receiving time of the calibration chirp CC2 and the expected receiving time, so that the latency calibration unit 114B then adjusts the subsequent energy calibrated signal RP received from the energy calibration unit 114A based on the latency deviation to generate calibrated latency calibrated signal RD.

Continuously, as shown in FIG. 3A, the phase and amplitude calibration unit 114C is coupled to the latency calibration unit 114B and is configured to calculate a phase deviation based on the latency calibrated signal RD and the reference phase value, and to calculate an amplitude deviation based on the latency calibrated signal RD and the reference amplitude value. For example, in some embodiments, the latency calibrated signal RD includes a calibration chirp CC3 corresponding to the third timing in the input signal Rin. The phase and amplitude calibration unit 114C calculates the phase deviation between the calibration chirp CC3 and the reference phase value and the amplitude deviation between the calibration chirp CC3 and the reference amplitude value, so that the phase and amplitude calibration unit 114C then adjusts the subsequent latency calibrated signal RD received from the latency calibration unit 114B based on the phase deviation and the amplitude deviation to generate the calibrated signal RC. In some embodiments, the reference phase value and the reference amplitude value are the phase of the reference frame signal and the amplitude of the reference fram signal.

Therefore, by the aforementioned operations, the calibration circuit 114 calibrates the input signal Rin and outputs the calibrated signal RC.

In one embodiment, as shown in FIG. 3A, the storage circuit 118 is coupled to the calibration circuit 114 and is configured to record a plurality of parameters of the reference frame RFS. In one embodiment, these parameters include a reference energy value, an expected receiving time, a reference phase value, and a reference amplitude value, but it is not limited thereto in the present disclosure. In one embodiment, the calibration circuit 114 is configured to determine whether the storage circuit 118 stores the parameters of the reference frame RFS to set the input signal Rin corresponding to the reference frame RFS as the reference frame signal. For example, if the storage circuit 118 does not store the reference phase value and the reference amplitude value of the reference frame RFS, the calibration circuit 114 sets the input signal Rin corresponding to the reference frame RFS as the reference frame signal, stores the phase value and the amplitude value of the input signal Rin as the reference phase value and the reference amplitude value to the storage circuit 118, and replaces the reference energy value and the expected receiving time with the energy value and the receiving time of the input signal Rin.

As shown in FIG. 3A, the measurement circuit 116 is coupled to the phase and amplitude calibration unit 114C and is configured to obtain the radar reflection information RI according to the calibration signal RC.

Therefore, through the aforementioned functional operation of the signal processing circuit 110 of FIG. 3A, the WiFi device 100 can firstly perform the signal calibration process on the received input signal Rin, so as to obtain accurate radar reflection information RI according to the signal after the calibration process (i.e., the calibration signal RC).

Please refer to FIG. 3B, which is a flow chart of a radar transmission method 300 for the wireless network device 100 in FIG. 1.

At first, as shown in FIG. 1 and FIG. 3B, step S310 is executed and the signal processing circuit 110 is configured to generate the output signal Rout. Specifically, in step S310, the signal processing circuit 110 generates the output signal Rout through the signal generator 112. In one embodiment of step S310, as shown in FIG. 2, the output signal Rout is transmitted in the time slots RS1-RS2 (i.e., the time period from time t1 to time t2, and the time period from time t3 to time t4) with a plurality of radar frames RF, and is transmitted in the time slots WS1-RS2 (i.e., the time period from time t1 to time t2, and the time period from time t3 to time t4) with a plurality of wireless network (WiFi) packets WP.

Subsequently, as shown in FIG. 1 and FIG. 3B, step S320 is executed to receive the output signal Sout through the loop 150 to generate the input signal Rin by the receiving circuit 130, in which the output signal Sout corresponds to the output signal Rout and processed by the transmitting circuit 120.

Subsequently, as shown in FIG. 3B, step S330 is executed and the Wifi device 100 sets the reference frame RFS as the reference frame signal. Specifically, in step S330, the calibration circuit 114 sets the input signal Rin corresponding to the reference frame RFS as the reference frame signal. For example, as shown in FIG. 2, when the signal processing circuit 110 performs the radar transmission operation in the time slot RS1, the calibration circuit 114 sets the radar frame RF initially transmitted in the time slot RS1 as the reference frame signal.

Subsequently, as shown in FIG. 3B, step S340 is executed and the signal processing circuit 110 compares the input signal Rin, the reference frame signal, and the expected parameters (for example, the expected energy, the expected receiving time, etc.) to generate the plurality of measurement chirps MC of the radar frame RF. Specifically, in step S340, the calibration circuit 114 compares the input signal Rin, the reference frame signal, and the expected parameters to adjust the signal generator 112 and the calibration circuit 114, so that the signal generator 112 generates the calibrated measurement chirps MC of the radar frame RF.

In one embodiment of step S340, the energy calibration unit 114A calculates the energy deviation based on the input signal Rin and the expected energy, and the energy calibration unit 114A generates and transmits the control signal CS to the signal generator 112 based on the energy deviation, so that the signal generator 112 adjusts the output signal Rout to the compensated output signal Rout′ according to the control signal CS, and the energy calibration unit 114A outputs the energy calibrated signal RP according to the input signal Rin corresponding to the compensated output signal Rout′. For example, if the output signal Rout has a signal energy of 10 dB and it is expected that the received input signal Rin has a signal energy of 8 dB (i.e., the expected energy difference is 2 dB), and the energy calibration unit 114A actually receives the input signal having the signal energy of 7.5 dB (i.e., the energy difference is 2.5 dB), the energy calibration unit 114A notifies the signal generator 112 of the 0.5 dB energy deviation by the control signal CS to control the signal generator 112 to compensate for the 0.5 dB energy deviation to the output signal Rout, so as to adjust the output signal Rout to the compensated output signal Rout′ having the signal energy of 10.5 dB. The signal energy of the input signal Rin is changed to 8 dB in response to the energy adjustment of the output signal Rout, so that the energy calibration unit 114A makes the input signal Rin with the signal energy of 8 dB as the energy calibrated signal RP.

In one embodiment of step S340, the latency calibration unit 114B calculates the latency deviation based on the receiving time of the energy calibrated signal RP and the expected receiving time, and adjusts the subsequent energy calibrated signal RP to the latency calibrated signal RD according to the latency deviation. In one embodiment, the receiving time of the energy calibrated signal RP can be the time that the latency calibration unit 114B actually receives the energy calibrated signal RP, and the expected receiving time can be the time that the latency calibration unit 114B is expected to receive the energy calibrated signal RP, but it is not limited thereto in the present disclosure. For example, if the expected receiving time is 2 s and the receiving time of the energy calibrated signal RP is 2.2 s, the latency calibration unit 114B adjusts the energy calibrated signal RP to the latency calibrated signal RD with a receiving time of 2 s.

In one embodiment of step S340, the phase and amplitude calibration unit 114C is configured to calculate the phase deviation based on the phase value of the latency calibrated signal RD and the reference phase value, and calculate the amplitude deviation based on the amplitude value of the latency calibrated signal RD and the reference amplitude value, so as to adjust the subsequent latency calibrated signal RD to the calibration signal RC according to the phase deviation and the amplitude deviation. For example, if the reference phase value and the reference amplitude value of the reference frame signal respectively are 180° and 1 volt, and the phase value and the amplitude value of the latency calibrated signal RD respectively are 150° and 0.95 volt, the phase and amplitude calibration unit 114C compensates for a phase deviation of 30° and an amplitude deviation of 0.05 volt to the latency calibrated signal RD to adjust the latency calibrated signal RD to a calibration signal RC with the phase value of 180° and the amplitude value of 1 volt.

Through aforementioned steps, energy of the output signal Rout in the radar frame generated by the signal generator 112 is calibrated, and the received input signal Rin is compensated by the calibration circuit 114. Alternatively stated, output energy of the measurement chirps following the calibration chirps in the radar frame is calibrated, and the latency, phase, and amplitude are compensated at the receiving end, so that the WiFi device 100 is competent in measuring during the radar frame.

Continuously, as shown in FIG. 1 and FIG. 3B, in step S350, the output signal Rout including measurement chirps is converted into the wireless emitting signal Wt by the transmitting circuit 120. For example, the DAC 122 converts the output signal Rout of a digital form into the transmission signal Aout of an analog form, and the transmission processing circuit 124 performs noise filtering, frequency adjustment, and signal amplification to the transmission signal Aout for generating the output signal Sout including measurement chirps to the transmitting end Tx. The transmitting end emits the wireless emitting signal Wt outward from the WiFi device 100 for measurement.

After the wireless emitting signal Wt reaches the the object to be tested 200, the wireless reflected signal Wr is formed. In step S360, the receiving circuit 130 receives the wireless reflected signal Wr and converts it to the input signal Rin, as shown in FIG. 1. For example, the receiving end Rx receives the wireless reflected signal Wr and generates the input signal Sin. The reception processing circuit 132 performs amplification, noise reduction, frequency adjustment, and noise filtering to the input signal Sin for generating the received signal Ain. Subsequently, the ADC 134 converts the received signal Ain of the analog form into the input signal Rin of the digital form.

Thereafter, as shown in FIG. 3B, step S370 is executed and the signal processing circuit 110 generates the plurality of radar reflection information RI based on the input signals Rin corresponding to the measurement chirps MC. Specifically, in step S370, the measurement circuit 116 analyzes the calibration signals RC to obtain the radar reflection information RI.

Therefore, as described in the aforementioned embodiments, the WiFi device 100 of the present disclosure combines the radar function to perform radar transmission operation and WiFi transmission operation, and perform the digital demodulation of the input signal Rin at the digital side (i.e., the signal processing circuit 110 communicatively connected after the receiving circuit 130) of the WiFi device 100 to reduce the hardware cost of the analog circuit, and reduce the signal energy at the transmitting end, the signal latency and the phase and amplitude deviations at the receiving end, thereby enhancing the overall performance of the WiFi device 100.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A wireless network device, configured for performing a radar transmission operation and a wireless network transmission operation, the wireless network device comprising:
a signal processing circuit, comprising a signal generator for generating an output signal, wherein the output signal comprises a plurality of calibration chirps in a radar frame during the radar transmission operation;
a transmitting circuit, configured to transmit the output signal; and
a receiving circuit, configured to receive a signal corresponding to the output signal through a loop and to generate an input signal;
wherein, the signal processing circuit further comprises a calibration circuit which sets the input signal corresponding to a reference frame as a reference frame signal, and compares the input signal with the reference frame signal and a plurality of expected parameters to adjust the signal generator and the calibration circuit,
the signal generator is further configured to generate a plurality of measurement chirps of the radar frame, and the transmitting circuit is configured to convert the output signal including the plurality of measurement chirps into a wireless emitting signal, wherein the receiving circuit is configured to convert a wireless reflected signal corresponding to the wireless emitting signal into the input signal, so that the signal processing circuit generates a plurality of radar reflection information according to the input signal corresponding to the measurement chirps.

2. The wireless network device according to claim 1, wherein the calibration circuit comprises:
an energy calibration unit, configured to calculate an energy deviation based on the input signal and an expected energy in the expected parameters, and generate and transmit a control signal according to the energy deviation to the signal generator;
wherein, the signal generator further adjusts the output signal to a compensated output signal according to the control signal, the energy calibration unit further outputs an energy calibrated signal according to the input signal corresponding to the compensated output signal.

3. The wireless network device according to claim 2, wherein the calibration circuit further comprises:
a latency calibration unit, coupled to the energy calibration unit and configured to calculate a latency deviation based on a receiving time of the energy calibrated signal and an expected receiving time in the expected parameters, and adjust the energy calibrated signal to a latency calibrated signal according to the latency deviation.

4. The wireless network device according to claim 3, wherein the calibration circuit further comprises:
a phase and amplitude calibration unit, coupled to the latency calibration unit and configured to calculate a phase deviation based on a phase value of the latency calibrated signal and a reference phase value of the reference frame signal, and calculate an amplitude deviation based on an amplitude value of the latency calibrated signal and a reference amplitude value of the reference frame signal, so as to adjust the latency calibrated signal to a calibration signal according to the phase deviation and the amplitude deviation.

5. The wireless network device according to claim 4, wherein the signal processing circuit further comprises:
a measurement circuit, coupled to the phase and amplitude calibration unit and configured to analyze the calibration signal to obtain the radar reflection information.

6. The wireless network device according to claim 4, wherein the calibration signal comprises the measurement chirps of the radar frame.

7. The wireless network device according to claim 1, wherein an initial radar frame in a time slot is the reference frame.

8. The wireless network device according to claim 1, wherein the signal processing circuit further comprises:
a storage circuit, coupled to the calibration circuit and configured to record a plurality of parameters of the reference frame, the parameters comprising a reference phase value and a reference amplitude value.

9. The wireless network device according to claim 8, wherein the calibration circuit is configured to determine whether the storage circuit stores the parameters of the reference frame, so as to set the input signal corresponding to the reference frame as the reference frame signal.

10. The wireless network device according to claim 1, wherein
during the radar transmission operation in a first time slot, the output signal is in a first frequency band;
during the wireless network transmission operation in a second time slot different from the first time slot, the output signal is in a second frequency band, the first frequency band is different from the second frequency band.

11. A radar transmission method, configured for a wireless network device, the radar transmission method comprising:
generating an output signal, wherein the output signal comprises a plurality of calibration chirps of a radar frame in a radar transmission operation;
receiving the output signal through a loop to generate an input signal;
setting the output signal corresponding to a reference frame as a reference frame signal;
comparing the input signal, the reference frame signal, and a plurality of expected parameters to generate a plurality of measurement chirps of the radar frame; and
generating a plurality of radar reflection information according to the input signal corresponding to the measurement chirps.

12. The radar transmission method according to claim 11, further comprising:
calculating an energy deviation based on the input signal and an expected energy in the expected parameters;
generating a control signal according to the energy deviation;
adjusting the output signal to a compensated output signal according to the control signal; and
outputting an energy calibrated signal according to the input signal corresponding to the compensated output signal.

13. The radar transmission method according to claim 12, further comprising:
calculating a latency deviation based on a receiving time of the energy calibrated signal and an expected receiving time in the expected parameters; and
adjusting the energy calibrated signal to a latency calibrated signal according to the latency deviation.

14. The radar transmission method according to claim 13, further comprising:
calculating a phase deviation based on a phase value of the latency calibrated signal and a reference phase value of the reference frame signal;
calculating an amplitude deviation based on an amplitude value of the latency calibrated signal and a reference amplitude value of the reference frame signal; and
adjusting the latency calibrated signal to a calibration signal according to the phase deviation and the amplitude deviation.

15. The radar transmission method according to claim 14, further comprising:
analyzing the calibration signal to obtain the radar reflection information.

16. The radar transmission method according to claim 14, wherein the calibration signal comprises the measurement chirps of the radar frame.

17. The radar transmission method according to claim 11, further comprising:
setting an initial radar frame in a time slot as the reference frame.

18. The radar transmission method according to claim 11, further comprising:
recording a plurality of parameters of the reference frame, the parameters comprising a reference phase value and a reference amplitude value.

19. The radar transmission method according to claim 18, further comprising:
determining whether a storage circuit stores the parameters of the reference frame, so as to set the input signal corresponding to the reference frame as the reference frame signal.

20. The radar transmission method according to claim 11, further comprising:
during the radar transmission operation in a first time slot, the output signal being in a first frequency band; and
during a wireless network transmission operation in a second time slot different from the first time slot, the output signal being in a second frequency band, the first frequency band being different from the second frequency band.
